(19) United States
(12) Patent Application Publication
(10) Pub. No.: US 2005/0083111 A1
(43) Pub. Date: Apr. 21, 2005

(54) Switching circuit for producing an adjustable output characteristic

(76) Inventor: Markus Rademacher, Augusburg (DE)

Correspondence Address: Mark C Comtois;Duane Morris, 1667 K Street N W, Suite 700, Washington, DC, 20006, US

(21) Appl. No.: 10/484,554

(22) PCT Filed: Mar. 11, 2003
(86) PCT No.: PCT/EP03/02546

(51) Int. Cl. G05F 1/10

(52) U.S. Cl. 327/540

(57) ABSTRACT

The invention relates to a circuit to generate an output characteristic, having a constant voltage control circuit which receives a voltage supply and generates a constant output voltage; a current reduction section, which receives a control voltage and, depending on this, generates a control current which produces a change in the output voltage; and a limiter section which receives a lower and an upper limit voltage and optionally blocks or activates the current reduction section. The invention also relates to a corresponding method to generate an output characteristic.

### FIELD OF THE INVENTION

The invention relates to a circuit to generate an adjustable output characteristic and in particular a circuit to generate a variable output voltage using a constant voltage control circuit.

### BACKGROUND OF THE INVENTION

In the prior art, programmable or adjustable precision reference voltage generators are known, such as the AS 2431 from ASTEC Semiconductor, a division of Emerson Electric Company, Saint Louis, Mo., USA. A programmable reference voltage generator can supply an adjustable, constant output voltage largely independent of voltage supply fluctuations, whereby such a reference voltage generator preferably has a low temperature coefficient, a precise turn-on characteristic and low output impedance. To achieve the required input voltage, the reference voltage generator is connected to external components, in particular resistors. An example of a programmable reference voltage generator is illustrated in FIG. 1.

The reference voltage generator U shown in FIG. 1 is connected to a voltage supply V_{SUPPLY} via a multiplier R_{V}. A bridge circuit consisting of two resistors R_{B1}, R_{B2} is connected in parallel to the reference voltage generator U. The bridge circuit comprising the resistors R_{B1}, R_{B2} generates a defined reference voltage V_{REF}, adjustable via the resistors, which is applied to a reference input of the reference voltage generator U, so that a very precise, stable constant output voltage V_{OUT} is produced at its cathode K or output.

Whereas a stable, constant output voltage is required for many applications, there are other applications which need programmable or adjustable rising or falling voltage characteristics. An example of a voltage characteristic, which, for instance, is needed in power supplies for telecommunications facilities, is shown in FIG. 2. With an increasing control voltage V_{CONTROL}, the output characteristic illustrated in FIG. 2 rises steadily and monotonously; see the continuous line in FIG. 2. Provision can also be made for the output characteristic V_{OUT} for control voltage values V_{CONTROL} lying below a lower limit voltage V_{LIMIT1} or above an upper limit voltage V_{LIMIT2} to be cut off and restricted to a defined, low output voltage value. This results in an output voltage V_{OUT} which has a constant, low value up to the lower limit voltage V_{LIMIT1}, which rises to a defined higher value on exceeding V_{LIMIT1}, rises steadily and monotonously between the lower and upper limit voltage V_{LIMIT1} and V_{LIMIT2} and then when the control voltage V_{CONTROL} exceeds the upper limit voltage V_{LIMIT2} again falls to a constant, low value, which can be the same as or different to the constant low output voltage value on turning on the control voltage V_{CONTROL}. Such a characteristic can be used, for example, in power supplies to charge batteries, in particular, in telecommunications systems. We would like to point out that the characteristic in FIG. 2 is only one example of an adjustable output voltage characteristic and that there are numerous applications for various adjustable output voltage characteristics in all sectors of the electrical industry.

It is thus the object of the invention to provide a device and a method to generate an adjustable, exceedingly precise output characteristic, based on a constant voltage generator. The output characteristic should be particularly suitable for power supplies, battery charging units and suchlike, and even more particularly for application in telecommunications facilities.

### SUMMARY OF THE INVENTION

The above-mentioned object has been achieved by means of a circuit having the characteristics outlined in claim 1 as well as a method having the characteristics outlined in claim 14.

In accordance with the invention, a circuit to generate an output characteristic is provided that has a constant voltage control circuit which receives a voltage supply and generates a constant output voltage. This constant voltage control circuit can essentially correspond to the programmable reference voltage generator shown in FIG. 1. Moreover, the invention provides for the constant voltage control circuit to be connected to a current reduction section which receives a control voltage and, depending on this, generates a control current which produces a change in the output voltage, to produce, in particular, a monotonous, steady rise or fall in the output voltage. The invention additionally provides a limiter section, connected to the current reduction section, which receives a lower and an upper limit voltage and, depending on this, can optionally block or activate the current reduction section. The limiter section thus makes it possible to optionally switch on or off the influence on the output voltage of the constant voltage control circuit by the current reduction section.

The invention provides a simple solution in terms of design and circuitry which can be largely integrated and realized at low-cost to generate a specified, adjustable output characteristic with great accuracy and stability. The invention achieves this by using a stable, programmable reference voltage generator which generates a fixed, constant output voltage and by adding a variable current reduction circuit to make the output voltage characteristic adjustable, as well as a limiter in order to achieve a further means of influence, in particular, a cut off of the out-put characteristic. While the supply voltage of the circuit presented in the invention can have strong fluctuations e.g. in the region of 20%, according to the invention, an output characteristic with an accuracy of +/−0.1% to 5% can be achieved, depending on the accuracy of the components used.

According to the invention, in the constant voltage control circuit a programmable reference voltage generator is preferably used whose output voltage is adjustable using a voltage divider. For instance, the above-mentioned shunt regulator AS 2431 from ASTEC Semiconductor or a suitable component from Alpha Semiconductor or Texas Instruments, for example, can be used as a reference voltage generator. It is clear that the invention is not restricted to a specific component.

In the constant voltage control circuit of the present invention, the voltage divider is preferably divided into a first ohmic section with two resistors and a second ohmic section with one resistor to allow the adjustable output characteristic to be to be influenced with particular ease, as described below.

In a preferred embodiment, the current reduction section has a resistor which is connected in series to one of the two. resistors in the first ohmic section so that the control current of the current reduction section flows through these two resistors connected in series in order to superimpose a voltage proportional to the control current on the output voltage. Depending on the design of the current reduction section, this can result in an increase or decrease in the output voltage.

The current reduction section is preferably activated via a first switching element which is contained therein in order to optionally activate or block the control current. This switching element is preferably activated via the limiter section.

For this purpose, in a preferred embodiment, the limiter section can have a comparator which receives the lower and the upper limit voltage as well as the control voltage, and generates a comparator output signal. This comparator output signal activates or deactivates the current reduction section via the first switching element. In addition, the limiter section can include a bypass circuit which is also activated or blocked depending on the comparator output signal.

The limiter section is preferably designed in such a way that it deactivates the current reduction section when the control voltage is less than the lower limit voltage or greater than the upper limit voltage, and otherwise activates it. Moreover, the limiter section can have a second switching element which also receives the comparator output signal and optionally activates or blocks the bypass circuit. In a particularly beneficial embodiment, the bypass circuit has a resistor which is connected in parallel to one of the two resistors in the first ohmic section of the voltage divider of the constant voltage control circuit. The bypass circuit is activated when the control voltage is less than the lower limit voltage or greater than the upper limit voltage, and is otherwise blocked. This means that, for control voltages which lie outside the interval between the lower and the upper limit voltage, the output characteristic of the circuit can be lowered to a defined constant voltage value. Of course, it is possible through an appropriate modification of the limiter circuit, by providing, for example, a series connection instead of the parallel connection of the bypass circuit, to raise the output voltage of the circuit to a defined constant value.

The invention also provides a method to generate an output characteristic with the following procedural steps: generating a constant output voltage depending on a voltage supply and a reference voltage; generating a control current depending on a control voltage and changing the output voltage depending on the control current; and optionally activating or blocking the control current depending on whether the control voltage lies within or without an interval between a lower and an upper limit voltage.

The invention is explained in more detail below based on a preferred embodiment and with reference to the drawings. In reading the following description, the technician will easily recognize that numerous modifications can be made to the illustrated circuit, particularly to generate a different characteristic to the one illustrated in FIG. 2, without departing from the scope of the invention. The figures show:

### SHORT DESCRIPTION OF THE DRAWINGS

FIG. 1 a circuit diagram of an interconnected programmable reference voltage generator in accordance with the prior art;

FIG. 2 an output characteristic of a circuit in accordance with the invention; and

FIG. 3 a circuit diagram of a circuit to generate an output characteristic in accordance with the invention.

### DETAILED DESCRIPTION OF PREFERRED EMBODIMENTS

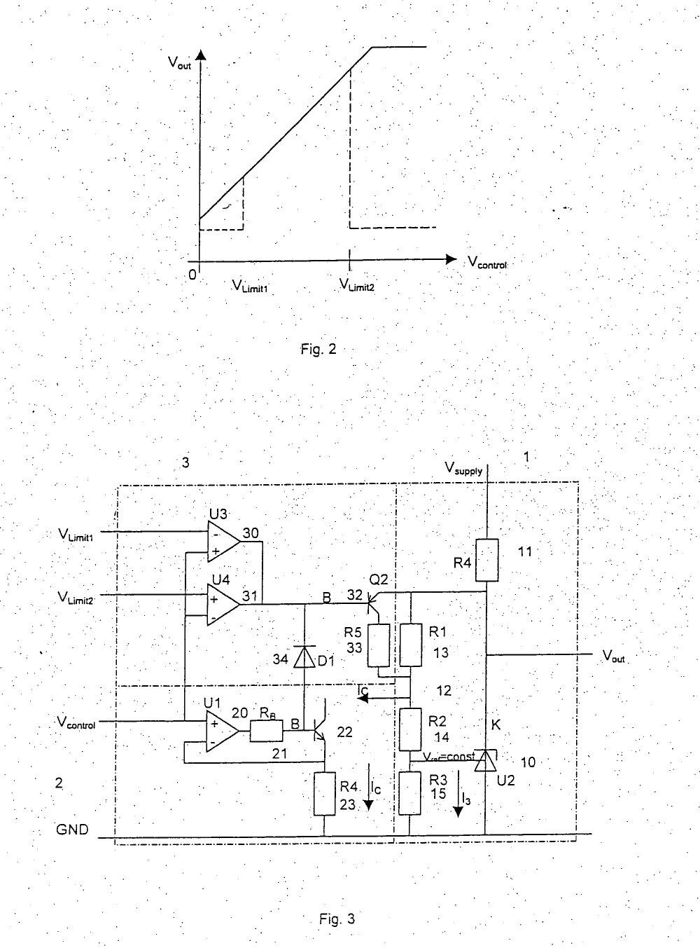

FIG. 3 shows a preferred embodiment of a circuit to generate the output characteristic which is illustrated in FIG. 2. The circuit basically consists of three sections, a constant voltage control circuit 1, a current reduction section 2 and a limiter section 3.

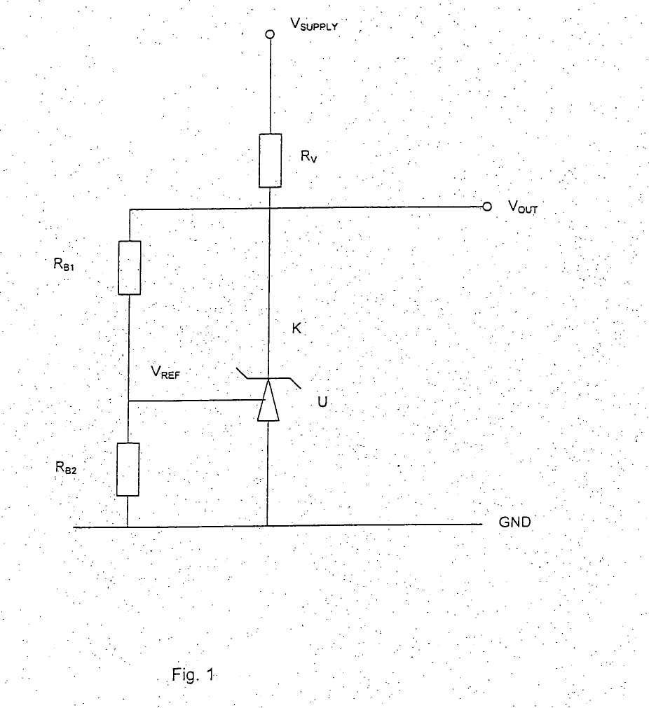

The constant voltage control circuit 1 is designed in a similar way to the programmable reference voltage generator which is illustrated in FIG. 1. The constant voltage control circuit 1 features a reference voltage generator 10, U2, which is connected to a voltage supply V_{SUPPLY} via a multiplier 11, R4. A voltage divider 12 is connected in parallel to the reference voltage generator 10 which has a first ohmic section with two resistors 13 and 14, R1 or R2, and a second ohmic section with one resistor 15, R3. The reference voltage generator 10, which, in practice, is also referred to as a programmable shunt regulator, generates a very precise and stable, constant output voltage V_{OUT} at its output or cathode K which is dependent on a reference voltage V_{REF} at the control input C of the reference voltage generator U2. The reference voltage V_{REF} is adjusted by the voltage divider 12 and, in particular, by the relationship of the first ohmic section 13, 14 to the second ohmic section 15. The output voltage V_{OUT} of the

[symbol]

1. A circuit for generating an adjustable output comprising:
a constant voltage control circuit (1) which receives a voltage supply (V_{SUPPLY}) and generates a constant output voltage (V_{OUT});
a current reduction section (2) which receives a control voltage (V_{CONTROL}) and, generates a control current (I_{C}) which produces a change in the output voltage (V_{OUT}); and
a limiter section (3) which receives a lower and an upper limit voltage (V_{LIMIT1}, V_{LIMIT2}) and optionally blocks or activates the current reduction section (2).

2. The circuit according to claim 1, wherein the constant voltage control circuit (1) further comprises a programmable reference voltage generator (10) whose output voltage (V_{OUT}) can be adjusted via a voltage divider (13, 14, 15).

3. The circuit according to claim 2, wherein the voltage divider (13, 14, 15) includes a first ohmic section with two resistors (13, 14) and a second ohmic section with one resistor (15).

4. The circuit according to claim 3, wherein the current reduction section (2) further comprises a resistor (23) which is connected in series to one (13) of the two resistors in the first ohmic section so that the control current (I_{C}) flows through the one resistor (23) of the current reduction section and through one (13) of the two resistors in the first ohmic section in order to superimpose a voltage (I_{C}.R1) proportional to the control current (I_{C}) on the output voltage (V_{OUT}).

5. The circuit according to claim 1, wherein the current reduction section (2) further comprises a first switching element (22) which optionally activates or blocks the control current (I_{C}).

6. The circuit according to claim 1, wherein the limiter section (3) comprises a comparator (30, 31) which receives the lower and the upper limit voltage (V_{LIMIT1}, V_{LIMIT2}) as well as the control voltage (V_{CONTROL}), and generates a comparator output signal.

7. The circuit according to claim 6, wherein the limiter section (3) blocks or activates the current reduction section (2) as a function of the comparator output signal.

8. The circuit according to claim 7, wherein the comparator output signal of the limiter section (3) is connected to the first switching element (22) of the current reduction section (2) to activate or block the control current (I_{C}).

9. The circuit according to claim 8, wherein the comparator output signal is connected to the first switching element (22) via at least one diode (34).

10. The circuit according to claim 8, wherein the first switching element (22) blocks the control current (I_{C}) when the control voltage (V_{CONTROL}) is less than the lower limit voltage (V_{LIMIT1}) or greater than the upper limit voltage (V_{LIMIT2}).

11. The circuit according to claim 7, wherein the limiter section (3) further comprises a second switching element (32) which receives the comparator output signal and optionally activates the bypass circuit (32, 33).

12. The circuit according to claims 11, wherein the bypass circuit (32, 33) comprises a resistor (33) which is connected in parallel to one (13) of the two resistors in the first ohmic section via the second switching element (32).

13. The circuit according to claim 12, wherein the second switching element (32) activates the bypass circuit (32, 33) when the control voltage (V_{CONTROL}) is less than the lower limit voltage (V_{LIMIT1}) or greater than the upper limit voltage (V_{LIMIT2}).

14. A method for generating an output characteristic comprising the following steps:
generating a constant output voltage as a function of a voltage supply and of a reference voltage;
generating a control current depending on a control voltage and changing the output voltage as a function of the control current; and
optionally activating or blocking the control current depending on whether the control voltage lies within or without an interval between a lower and an upper limit voltage.

15. The method of claim 14, wherein the output characteristics is a variable output voltage.

16. The circuit according to claim 6, wherein the limiter section (3) activates a bypass circuit (32, 33) to generate a voltage drop in the output voltage (V_{OUT}).

17. The circuit according to claim 8, wherein the first switching element (22) activates the control current (I_{C}) when the control voltage (V_{CONTROL}) is substantially between the lower limit voltage (V_{LIMIT1}) and the upper limit voltage (V_{LIMIT2}).

18. The circuit according to claims 3 wherein the bypass circuit (32, 33) comprises a resistor (33) which is connected in parallel to one (13) of the two resistors in the first ohmic section via the second switching element (32).
